(19) United States
(12) Patent Application Publication
(10) Pub. No.: US 2002/0176377 A1
(43) Pub. Date: Nov. 28, 2002

(54) Service platform on wireless network

(76) Inventor: Thomas E. Hamilton, Marlborough, MA (US)

Correspondence Address: J. ROBIN ROHLICEK, J.D., PH.D., Fish & Richardson P.C., 225 Franklin Street, Boston, MA, 02110-2804, US

(21) Appl. No.: 10/061,524

(22) Filed: Feb. 2, 2002

Related U.S. Application Data
(60) Provisional application No. 60/292,564, filed on May 22, 2001.
(60) Provisional application No. 60/293,756, filed on May 25, 2001.

(51) Int. Cl. H04Q 7/00

(52) U.S. Cl. 370/328; 370/338; 455/406

(57) ABSTRACT

A method of operating a wireless network is provided. A method of providing a sponsored packet switched data service including receiving a request in a wireless network for a sponsored packet switched data service from a user, determining a sponsor for the requested service in accordance with stored policies, determining a billing in accordance with the stored policies, monitoring a session between the user and the sponsor, and billing the sponsor on completion of the session. A method includes, in a wireless network, receiving a request from a user for a packet switched data service, determining a provider for the service according to stored policies, determining a billing arrangement for the service according to the stored policies, and tracking the service between the user and the provider.

### CROSS-REFERENCE TO RELATED APPLICATION

This application claims the benefit of U.S. Provisional Applications No. 60/292,564 filed May 22, 2001, “Method for Sponsored Packet Switched Data Services on a Wireless Network,” and No. 60/293,756 filed May 25, 2001, “Method for Transaction Based Packet Switched Data Services on a Wireless Network.” These applications are incorporated herein by reference.

### BACKGROUND

This invention relates to providing data services in a data communication system.

First generation wireless telephone networks, such as AMPS (Analog Mobile Phone Service) networks, used analog radio transmission architectures to provide mobile communications that enabled users of mobile telephones to connect to providers of analog services, such as voice-based services. These systems did not directly support data communication between mobile telephones and other computers or devices through the wireless rework.

Most wireless systems today are digital and are based on a number of different radio transmission techniques and system architectures including GSM (Global System for Mobile communication), TDMA (Time Division Multiple Access) and CDMA (Code Division Multiple Access). These digital systems are generally referred to as second-generation (2G) systems. In general, these 2G systems make use of digital circuit switched connections to provide mobile services in which mobile terminals (e.g., mobile telephones) are connected with particular destinations. The most common services offered over such wireless networks are voice-based services such as land-to-mobile, mobile-to-land, mobile-to-mobile calls. The voice signals for the calls are digitally encoded during radio transmission between the mobile terminals and the fixed mobile network. In the fixed mobile network, the encoded voice traffic is handled and switched on an individual circuit basis, for example switching the traffic to another mobile terminal on the same wireless network, to the Public Switched Telephone Network (PSTN), or to another Public Land Mobile Networks (PLMN).

Support for data services in these second-generation wireless networks is somewhat limited. One type of data service in these systems is a short message services (SMS), which enables unidirectional transmission of short datagrams of up to 256 bytes in length to the mobile telephone. Some 2G systems, such as GSM based systems, also allows bi-directional transmission of SMS messages. However, SMS is designed for the transmission of independent messages, which can tolerate a reasonable delivery delay across the network.

Another type of data service in 2G systems is a circuit-switched data (CSD) service in which a mobile terminal (e.g., a mobile telephone of a computer coupled through a mobile telephone) establishes a data circuit to a particular destination. While the mobile terminal is connected, it makes dedicated use of one or more channels of the type that are used to carry encoded voice traffic. The entire capacity of these channels is allocated to the user, and the user is typically charged on the basis of the duration of the “call.” For example, the mobile terminal may connect to a gateway to a data network, such as the Internet, and a fixed-rate data channel is established and reserved between the mobile terminal and the gateway. Thus CSD is not particularly efficient for communication over packet switched data networks in which the traffic is “bursty” (i.e., highly variable data rate) in nature because much of the capacity of the data channels goes unused. For example, “Web browsing” from a mobile terminal to servers on the Internet typically results in bursty use of the data channel.

To enable second-generation networks to more optimally provide a bearer service for packet switched data communication between mobile terminals and fixed networks, upgrade technologies such as the General Packet Radio System (GPRS) have been developed. GPRS augments GSM systems to more efficiently handle packet switched data. GPRS is more efficient in part by not reserving entire channels for particular mobile terminals. In a GPRS-based system, several nodes are added into a standard mobile network architecture. Packet Control Units (PCUs) are used to provide a packet data switched interface to the radio interface of the network. One or more Serving GPRS Support Nodes (SGSNs) and a Gateway GPRS Support Node (GGSN) are also added to provide a data path from the PCUs to the external networks. Other GPRS related nodes may be added, however these are typically the minimum requirement to implement GPRS on a second-generation network. A GPRS enabled network still handles voice-based services using circuit switched methods. However, an important distinction of GPRS for data transmissions is that, unlike CSD, GPRS is specifically designed for the transport of packet switched data. Because of this feature, multiple users, even within the same serving radio cell, can share the radio and fixed bearer resources of the network. This significantly increases the resource efficiency and improves network utilization. GPRS can theoretically provide user application data rates up to 115 kB/sec, although this is dependent upon the radio link conditions and requires specific compatibility for this mode by both the network radio interfaces and the mobile terminals. As the data bearer service is based on packet switched data from the mobile terminal throughout the network, multiplexing on the bearer service is readily possible such that multiple application data streams can be carried between the mobile terminal and different points internal and external to the wireless network. For example, a user could simultaneously web browse, check e-mail, run a videophone session and download a file.

### SUMMARY

In an aspect, the invention features a method of providing a sponsored packet switched data service including receiving a request in a network for a sponsored packet switched data service from a user, determining a sponsor for the requested service in accordance with stored policies, determining a billing in accordance with the stored policies, monitoring a session between the user and the sponsor, and billing the sponsor on completion of the session.

Embodiments may include one or more of the following.

The stored policies may include pre-arrangements between a network provider and sponsors of packet switched data services.

In embodiments, the stored polices may include factors. The factors may include a user identity, a user location, a time of day, a user class, a service provider class, network conditions, pre-agreement rules and/or governmental regulations.

The sponsor may be a packet switched data service provider, an operator of the network, and/or a third party packet switched data service.

Monitoring the session may include detecting a start of the session with a set of detection points, tracking the session in a session charging record, and detecting an end of the session with the set of detection points.

In embodiments, detecting the start of the session may include detecting starts of sub-sessions within the session with the set of detection points. Tracking further may include tracking the sub-sessions. Detecting the end may include detecting the end of each of the sub-sessions within the session with the set of detection points.

Billing may include sending the charge record to the sponsor.

In embodiments, the network may be a second generation wireless network, a Global System for Mobile communication (GSM) network, a General Packet Radio System (GPRS) enabled GSM, a Time Division Multiple Access (TDMA) network, a Code Division Multiple Access (CDMA) network, or a Universal Mobile Telecommunications System (UMTS) network. The network may be a TETRA network, a Tetrapol network, a DECT network, an AMPS network, a wireless local area network (WLAN), or a third generation wireless network. The network may also be a fixed network.

In another aspect, a method includes, in a wireless network, receiving a request from a user for a packet switched data service, determining a provider for the service according to stored policies, determining a billing arrangement for the service according to the stored policies, and tracking the service between the user and the provider.

Embodiments may include one or more of the following.

The stored polices include how the user is to be billed and a basis for the billing, policy decisions that are entrusted to the provider, pre-arrangements between an operator of the network and the provider.

In embodiments, the stored policies may include matching a provider to a user's time of connection, matching a provider to a user's location, matching a provider to a time of day, matching a provider to a user class, matching a provider to a service class, and/or matching a provider to network conditions.

Tracking may include detecting a start of the session with a set of detection points, tracking the session in a session charging record, and detecting an end of the session with the set of detection points.

In embodiments, detecting a start of the session may include detecting starts of sub-sessions within the session with the set of detection points. Tracking may also include tracking the sub-sessions in the session with the set of detection points.

Detecting the end may include detecting the end of each of the sub-sessions.

Billing may include sending the charge record to the user.

The method may also include determining whether the user is authorized to use the service, and/or checking a user account for payment history.

In embodiments, the method may also include billing the user upon completion of the session, and reconciling billing between a network operator and the provider.

The user session may include multiple transaction sessions represented by multiple sub-sessions.

In embodiments, the wireless network may be a second generation wireless network, a Global System for Mobile communication (GSM) network, a General Packet Radio System (GPRS) enabled GSM, a Time Division Multiple Access (TDMA) network, a Code Division Multiple Access (CDMA) network, or a Universal Mobile Telecommunications System (UMTS) network. The wireless network may be a TETRA network, a Tetrapol network, a DECT network, an AMPS network, a wireless local area network (WLAN), or a third generation wireless network.

Embodiments of the invention may have one or more of the following advantages.

A wireless network is capable of carrying packet switched data so that one or more packet switched data services on the network are sponsored by another for a user.

The method allows the user to transparently obtain and use the packet switched data services without charge or toll.

The sponsor can be the provider of the packet switched data services, the operator of the network, third parties or combinations thereof.

A selected service provider is identified as a sponsor and a connection between the user and service provider monitored to produce billing units. The wireless network operator charges the selected packet switched data service provider account with the billing units based upon network usage such as packet volume, user location, time of day, type of service provided, and user class over the duration of a session with the packet switched data service. The session may be monitored to determine information units that are based upon the usage of the data service.

The network operator may be selected to provide the service and is identified as the sponsor. The session between the user and service provider is monitored to produce billing units. The network operator charges an internal account with the billing units based upon network usage such as packet volume, user location, time of day, type of service provided, and user class over the duration of a session with the packet switched data service. Optionally, the session is monitored to determine information units that are based upon the usage of the data service.

The method provides a monitoring and billing technique that combines network usage and service usage.

The technique provides transaction-based services (push or pull) in a context of packet switched data services over a wireless network where a network operator can directly bill a user of the packet switched data services.

A technique of operating a wireless network that is capable of carrying packet switched data is provided so that one or more packet switched data services on the network can be charged on a transaction basis to a user by a network operator.

The technique allows the user of a wireless network to obtain and use packet switched data services of a multiplicity of service providers while being billed for a cost of each transaction and associated cost of the network service in a single invoice by the operator of the network.

A provider of transaction based packet switched data services may be selected from a universe of service providers that are able to furnish a requested packet switched data service, and can be an operator of the network and/or third parties.

An operator of a wireless network charges a user account with billing units based upon network usage and packet switched data service usage, such as packet volume, user location, time of day, type of service provided, and user class, over a duration of a user session. The payments by the user to the operator of the network are reconciled between the operator and the service provider.

Other features and advantages of the invention are apparent from the following description, and from the claims.

### DESCRIPTION OF DRAWINGS

FIG. 1 is a diagram of a wireless communication system for providing data services to a number users of mobile stations;

FIG. 2 is a system architecture diagram for the wireless communication system of FIG. 1 in a GSM/GPRS environment;

FIG. 3 is a diagram of the logical architecture of a Mobile Switching Services Platform (MSSP);

FIG. 4 is a diagram of the architecture of the Service Control Layer of the MSSP;

FIG. 5 is a diagram illustrating use of detection points in a TCP flow;

FIG. 6 is a diagram of the physical architecture of an MSSP;

FIG. 7 is a block diagram of a I/O module and a service module of an MSSP;

FIG. 8 is a flowchart for a sponsored data service; and

FIG. 9 is a flowchart for a transaction based data service.

### DESCRIPTION

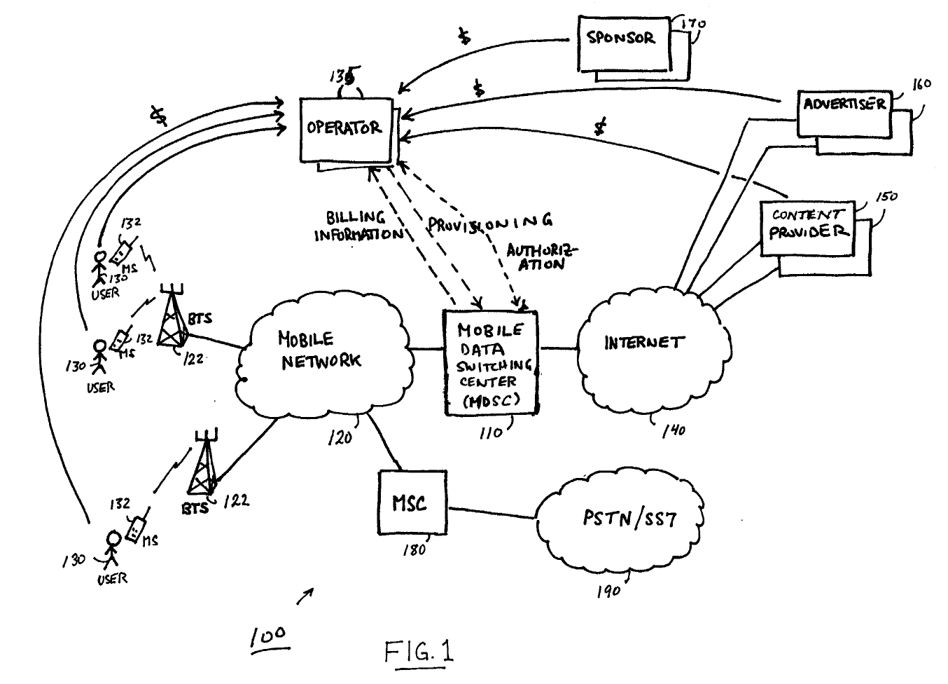

Referring to FIG. 1, in a wireless communication system 100 data communication between a number of mobile stations (MSs) 132, such as wireless cellular telephones, and a number of content providers 150, such as Web servers, is handled by a mobile data-switching center (MDSC) 110. Mobile terminals 132 are operated by mobile users 130 and communicate over wireless links to base transceiver stations (BTS) 122. The BTS 122 are coupled to MDSC 110 over a mobile network 120, which provides a fixed network communication infrastructure for passing communication between MDSC 110 and MSs 132. MDSC 110 is also coupled to content providers 150 over a data network, here over public Internet 140.

Wireless communication system 100 also supports voice communication between MSs 132 and a telephone network, Public Switched Telephone Network (PSTN/SS7) 190, which is controlled by a Signaling System 7 (SS7) infrastructure. A mobile switching center (MSC) 180 is coupled between mobile network 180 and

Mobile data switching center (MDSC) 110 provides enhanced handling of mobile data communication sessions between MSs 132 and content providers 150. One type of handling relates to monitoring of the sessions for billing purposes.

One aspect of this monitoring relates to tracking and processing individual sessions that occur while a MS 132 is in data communication over Internet 140. For instance, MS 132 may establish data communication through mobile network 120 for a period of time. MS 132 is assigned an Internet Protocol (IP) address to use for the duration of the period it is in data communication through mobile network 120, and can communicate with other devices over Internet 140 essentially in the same manner as fixed computers coupled to the Internet. Therefore, MS 132 can establish a number of communication sessions with different content providers 150, and these sessions can overlap in time. Examples of content providers include content servers, such as today's Web servers which provide content using HTTP (Hyper Text Transport Protocol) or mail servers that provide mail messages using POP (Post Office Protocol).

MDSC 110 implements a services model for data interactions between MSs 132 and content providers 150. Taken abstractly, a “service” describes the delivery of content or functionality to a user 130, typically in such a way as to provide value to the user. A particular service defines interactions with users each of which have a beginning, middle, and an end and is typically associated with a particular content provider 150.

Operator 135 provisions a number of services of various types on MDSC 110. The system can include an operator 135 of the physical wireless network as well as a number of Mobile Virtual Network Operators (MVNOs). For example, different services may be associated with different content providers 150. A service typically defines charging information to be captured to generate detail records related to use of the service by users 130. The definition of a service may also provide class of restriction information that may be applied against users or groups of users to inhibit a particular service or features associated with a given service. MDSC 110 optionally collects performance and usage metering, which it can provide to operator 135. MDSC 110 creates service detail records (SDRs) to provide a partial or complete summary of a service interaction, which it also provides to operator 130. One use of the SDRs by operator 130 is for billing. Typically a single SDR will be created to summarize a service interaction with a particular user, although partial records can optionally be generated for resource intensive service interactions to ensure that at least partial billing records will be available in the event of a complete system failure. Multiple SDRs can also be generated when the charges for a service interaction are split among several parties, for example, between an advertiser, a subscriber, and a sponsor.

As part of the definition of a service that operator 130 provisions on MDSC 110, an initial detection point specifies the start of an interaction with a user 130 of the service. MDSC 110 monitors and controls many different types of data packets, at a variety of protocol layers, according to state machines each responsible for specific types of packets. Within each state machine there are certain strategic places where important information becomes available or key control decisions can be made. These places are called detection points. A service definition identifies a particular detection point as the initial detection point for the service. When MDSC 110 identifies such an initial detection point in data flowing through it, service logic for the associated service is executed. The service logic typically defines the user interaction with the service for the duration of the interaction. During the service interaction, the service logic registers additional detection points in various of the state machines to gain real-time access to the packet data and to allow it to influence the control decisions made by the state machine.

MDSC 110 inspects all data packets passing between the MS 132 and the Internet 110. Between occurrences of detection points for an application, data passes through MDSC 110 without the intervention of the service logic. Therefore, most packets are inspected and passed through MDSC 110 with little or no additional delay due to the inspection. Some packets, such as packets associated with starts or ends of communication sessions may require additional processing, and may be intercepted and delayed until acted upon by service logic that is implemented in the MDSC or in external service platforms coupled to the MDSC.

MDSC 110 processes data communication at various layers of the protocol stack. For instance, MDSC 110 processes IP, UDP, TCP or other protocols, as well as sessions within higher layer protocols such as HTTP. Furthermore, MDSC 110 processes “sub” sessions of what a user 130 perceives as a “session.” For example, when a user accesses a HTML (Hyper Text Markup Language) document on a Web server, this may result in data being sent to the user from a number of different content providers. For example, a separate “sub” session is established between MS 132 and an advertiser 160 to deliver advertising content from the advertiser while the content the user is seeking may come from the content provider. In general, MDSC 110 processes session data at any of layer 2 (data link layer) through layer 7 (application layer) of the standard ISO protocol stack.

Based on monitoring of the communication data passing through MDSC 110, MDSC 110 passes various types of detail records to an operator 130 of the wireless system, typically in “real time” (i.e., with low delay as opposed to periodic batch processing). Different billing policies are applied by the operator to the communication sessions according to the service being performed. The differences in the policies include the basis for the billing, such as a duration of the session, an amount of data transferred during the session, or a number or type of transactions with the content provider carried out during the session. Another difference in the policies includes the payer for the session, which can include one or more of the user 132, content provider 150, or advertiser 160 with whom the user communicated. The payers can also include a sponsor 170 for a session, who may not have been directly involved in the communication with the user. An example of a sponsor is a user's employer.

In addition to monitoring communication data for billing purposes, MDSC 110 monitors the communication for control purposes. An example of control of communication sessions is access control involving determining whether a user is authorized to establish a particular session. For example, access control may be based on the user having subscribed to the service to which the user is attempting to be connected. Access control can also be based on a prepayment model in which the user can access the service if they have a sufficient balance in their account. Other types of access control can be based on the user providing credentials (e.g., a password) or agreeing to pay for the service being accessed. The MDSC may communicate with operator 130 to determine whether the user is authorized to establish the session.

Another form of control of communication sessions involves redirection. A user may attempt to establish a communication session with a service, and based on monitoring of that attempt, MDSC 110 redirects the communication to a particular content provider 150. This redirection may involve redirecting a request to establish a communication session with one content provider 150 to another content provider 150. The redirection may also involve redirecting a request to communicate with a “virtual” service to an actual content provider 150. For example, a service may be identified by a name, such as “Flowers” and MDSC 110 redirects the request to a content provider that provides online ordering of flowers. The nature of the redirection is configurable. The redirection can depend on particular characteristics of the user attempting to establish the session, for example, depending on whether they have subscribed to the “Bouquet” service. The redirection can also depend on the characteristics of the mobile station (MS) 132 being used by the user, for example, depending on the geographic location of the MS, or the capabilities of the MS device.

These forms of redirection share many characteristics of redirection of telephone calls in an Intelligent Network (IN) based telephone system. For example, if a user dials a toll-free telephone number, such as 1-800-FLOWERS (1-800-356-9377), the call is detected by a telephone switch. An external platform, in particular a Service Control Point (SCP), receives notification of the detected toll-free number and determines the actual telephone number to which to direct the call. In the data service approach described above, the MSSP can request that an external platform determine where to direct a virtual data service.

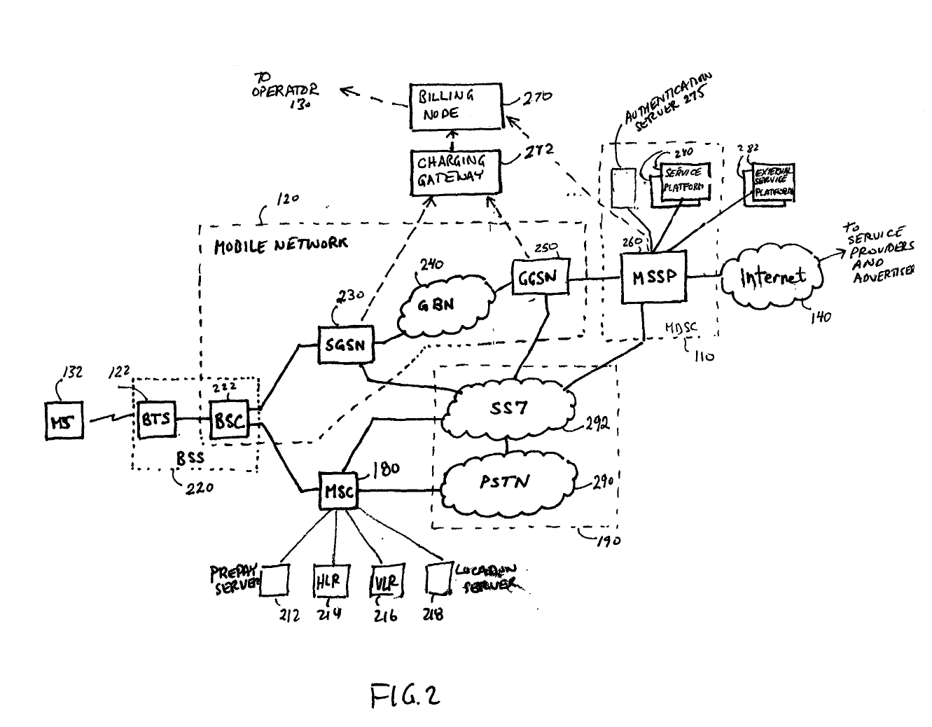

Referring to FIG. 2, in one version of wireless system 100, the functionality of the system shown in FIG. 1 is implemented in a GSM-based system in which data communication is provided according to the General Packet Radio Service (GPRS) approach. In this version, an additional network element, mobile service switching processor (MSSP) 260 is inserted into an essentially standard GSM/GPRS architecture in the communication path between mobile network 120 and Internet 140. In general, MSSP 260 implements the session monitoring and control functions described in the overview above.

In this version of the system, a Gateway GPRS Support Node (GGSN) 250 provides a gateway for communication between MSs 132 and external networks, such as Internet 140. Within mobile network 120, a Base Station Controller (BSC) 222, which together with one or more BTSs 122 connected to it form a Base Station System (BSS) 220, provides the fixed end of radio communication with one or more MS 132. As a MS 132 travels, even while in voice or data communication with the system, the MS may communicate with a number of different BSS 222, and the system manages this mobility according to standard techniques to maintain communication with the MS.

Voice and data communication from MS 132 is split at a Packet Control Unit (PCU, no shown) of a BSC 222. Voice communication is passed to Mobile Switching Center (MSC) 180 while data communication is passed to a Serving GPRS Support Node (SGSN) 230. MSC 180 sets up voice circuits over PSTN 290 using control communication over SS7 network 292. Control of these voice circuits can include supporting pre-paid voice services in which MSC 180 accesses servers over the SS7 network to determine whether the use has an adequate balance to make the call.

MSC 180 communicates with a number of servers in providing voice communication service. These include a prepay server 212, a home location register (HLR) 214, a visitor location register (VLR) 216, and a location server 218.

Data communication passes between BSC 222 and SGSN 230. In general an SGSN 230 supports multiple BSS 220, and each BSS 220 connects to a single SGSN 230. Each SGSN 230 communicates with a GGSN 250 over GPRS Backbone Network (GBN) 240, which is typically a private data network coupling the SGSN and GGSN nodes.

When user 130 wants to establish data communication from MS 132, the user initiates a request sent by MS 132 to attach itself to the data network. This request is received by BSS 220 and then passed to SGSN 230. SGSN 230 receives the MS identification, typically the International Mobile Subscriber Identity (IMSI) and authenticates the user. The MS requests that the SGSN create a PDP (Packet Data Protocol) Context, which identifies an Internet Protocol (IP) address or indicates that it needs a dynamically assigned address. The SGSN passes this request to the GGSN, which essentially creates the data communication link and acts as a gateway for communication between the MS and an external network. The MS can request a connection to a specified network. In this example, we assume that the MS requests connection to the public Internet. After the PDP context is established, the MS essentially has a virtual link between it and the GGSN, which is providing the gateway function to the external network.

During establishment of the PDP context, GGSN 250 communicates with an authentication server 275, such as a RADIUS server. MSSP 260 detects and monitors the interchange with the authentication server. Using the monitored information, MSSP 260 determines the mapping between the identity of MS 132 and the IP address used by the MS for communication over the Internet. In alternative embodiments, such as those in which authentication is not performed using communication that passes through the MSSP, MSSP 260 obtains the mapping information externally such as over SS7 network 292. For example, MSSP 260 can communicate over the SS7 network to obtain information from the servers 212-218 that are used by MSC 180.

Both SGSN 230 and GGSN 250 create call detail records (CDRs) related to an MS 130 PDP context, which the pass to a charging gateway 272 which performs some processing and matching of the CDRs and forwards billing information to billing node 270. In general, SGSN 230 collects information about the radio portion of the virtual data link between MS 132 and GGSN 250. For instance, the SGSN collects the total duration of the connection and amounts of data sent to or from the MS. In general, GGSN 250 collects information about the external network portion of the communication, including the network connected to (e.g., the Internet), the duration of the PDP context, and the amount of data sent back and forth the external network.

After an MS 132 establishes the virtual data link to GGSN 250, MS 132 is able to initiate communication to Internet 140. For example, a MS 260 may first attempt to contact a Domain Name Server (DNS), which is a computer on Internet 140 that translates a text-based host name into a numeric address. MSSP 260 detects the initial translation request as well as the response.

MSSP 260 monitors all communication between each MS 132 and hosts on Internet 140. MSSP 260 identifies the source MS of each packet according to its source IP address. During the course of monitoring this communication, MSSP 260 generates a number of detail records, which it forwards to billing node 270. By having translated the user's IP address to their IMSI, these detail records directly identify the user's IMSI, MSDN, or both, without necessarily requiring further translation.

As MSSP 260 detects certain points in communication sessions between the MS 132 and destinations on the Internet it generates detail records which it forward to billing node 270. Such points, or “detection points,” can include, for example the initiation or termination of IP flows to particular content providers. Furthermore, as introduced above, MSSP 260 also controls the IP flows and the associated protocol state machines. MSSP 260 communicates with administration and service platforms 280, which are separate computers coupled to the MSSP. These service platforms implement service logic that determines how events in the IP flows that are detected by the MSSP should handled. One or more of these platforms can be co-located with the MSSP and operated as a system forming MDSC 110, which was introduced in FIG. 1. MSSP 260 can also communicate with external service platform 282, for example, over a data network. For example, an external service platform 282 may be operated by a content provider 150 or by a virtual operator.

MSSP 260 is configurable to determine when to generate detail records, and when to block IP flows pending instructions from a service platform 280. This configuration can be statically provisioned. In addition, the configuration can be dynamically created or updated, for example, during the course of processing a communication session, or in response to external events, for example, a user entering a geographic area by the MSSP. The MSSP can optionally obtain this information over a link to the location server.

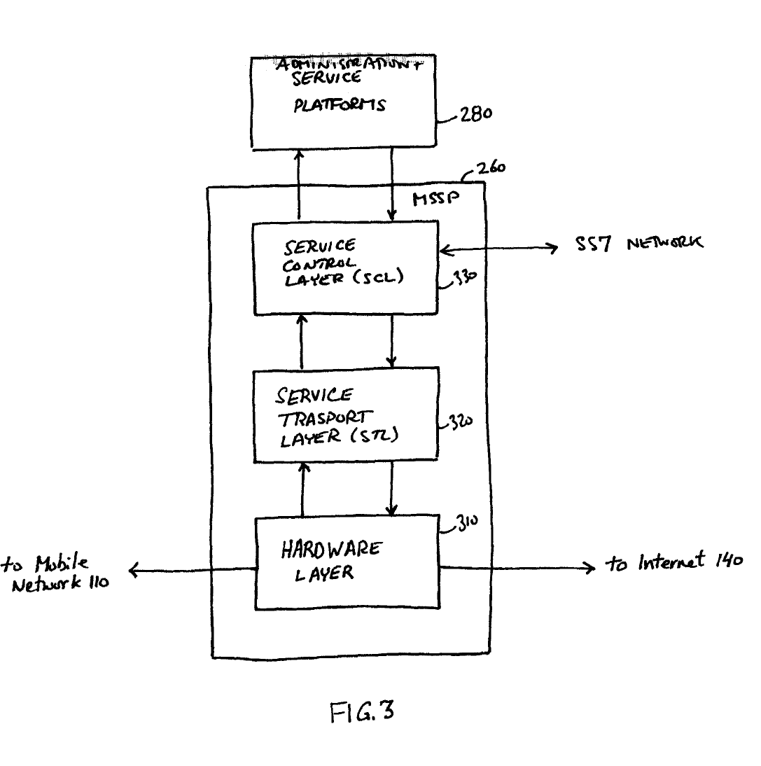

Referring to FIG. 3, MSSP 260 is architecturally divided into three distinct layers. A hardware layer 310 provides high-speed processing of packets passing between mobile network 110 and Internet 140. Certain packets are identified in hardware layer 310 as requiring further handling, and these are handled by of a Service Transport Layer (STL) 320 and possibly by a Service Control Layer (SCL) 330. When hardware layer 310 does not process a packet itself, it buffers the packet and sends information about the packet (but generally not the packets themselves) to STL 320, and waits for a reply from the STL before further processing the packet.

Hardware layer 310 implements physical data communication interfaces to the external networks, such as mobile network 110 and Internet 140 as well as interfaces to STL 320. The hardware layer also provides the capability to set triggers or event notifications based on IP flow characteristics which the hardware layer detects without the need for software assistance from higher layers in the architecture. Hardware layer 310 is designed to support Quality of Service restrictions on a per user per application basis. The hardware layer implements deep packet processing not only to enable trigger and event processing, but also to analyze data on the fly in real-time. Virtual output queuing system within the hardware layer allows for a fine degree of control that may be used for traffic shaping or policing IP flows. The hardware layer also provides SS7 connectivity.

STL 320 is responsible for managing hardware resources used to route packet traffic between the I/O ports of the MSSP as well as manipulate the various hardware registers that control the flow of data as well as setting triggers and detecting events. STL 320 either processes the information it receives from the hardware layer directly and informs the hardware layer how to process the packet, or passes information about the packets to the third layer, Service Control Layer (SCL) layer 330.

STL 320 is responsible for processing requests originated at SCL 330 related to subscriber sessions and request and notification detection points. STL 320 also implements an IP routing engine used to route packets onto the IP network. STL 320 detects session events and notifies the SCL. The STL controls hardware layer 310 and thereby determines how packet flows are handled. The STL is responsible for managing the hardware registers used to arm both trigger and event detection points and register event notifications.

SCL 330 provides an interface to administration and service platforms 280 and executes service logic associated with provisioned services and interfaces with STL 320 to control hardware layer processing of data passing through MSSP 260. The SCL implements the interface logic and state machines necessary to implement each API. Applications register with an API to set detection points, monitor connection status, and route service requests. The SCL layer will validate and translate API requests to STL requests as necessary to enable detection points and event monitoring.

STL 320 manages user sessions (i.e., PDP contexts) and different communication IP conversations, such as TCP sessions, within the overall user session. STL 330 also manages and inspects subscriber data packets and implement several types of flows and detection points. STL 320 supports address translation, packet filters, tunneled flows, and supervised flows. STL also counts packets as well as bytes sent and received belonging to any given flow. STL implements detection points on flows. Detection points can be based on individual flow type and can be based on patterns defined using protocol layers 2 through 7. STL will also provide capability to set detection points based on thresholds on the counter values, for example, setting a detection point to occur every 10 kB of data is transferred.

STL 320 provides a capability to limit IP address/port numbers for a given set of session groups. This capability can be used by the SCL to build packet-filtering service and network based firewalls.

STL 320 also provides capability to send packets meeting criteria to a pre-configured tunnel. The criteria are based on IP header and transport layer header characteristics. These flows can be used by SCL to build VPN capabilities. SCL 330 provides support for the various external MSSP interfaces, such as interfaces to service platforms 280. SCL 330 also implements interface logic and state machines that are used implement each API. The SCL can also communicate over the SS7 network, for example, to obtain information about subscribers. Applications executing on service platforms 280 register with an API to set detection points, monitor connection status, and route service requests. SCL 330 validates API requests from applications and translates them to STL requests, which it passes to STL 320 as necessary to enable request and notification detection points and event monitoring. SCL 330 is also responsible for housing the MSSP configuration database as well as the IP Detail Record (IPDR) database. SCL 330 also provides an interface to external network management systems for provisioning and fault management. The SCL collects data from STL 320, external applications executing on service platforms 280, and API state machines on a per service request basis in order to generate IPDRs for billing or service request statistics, which it forwards to the billing node.

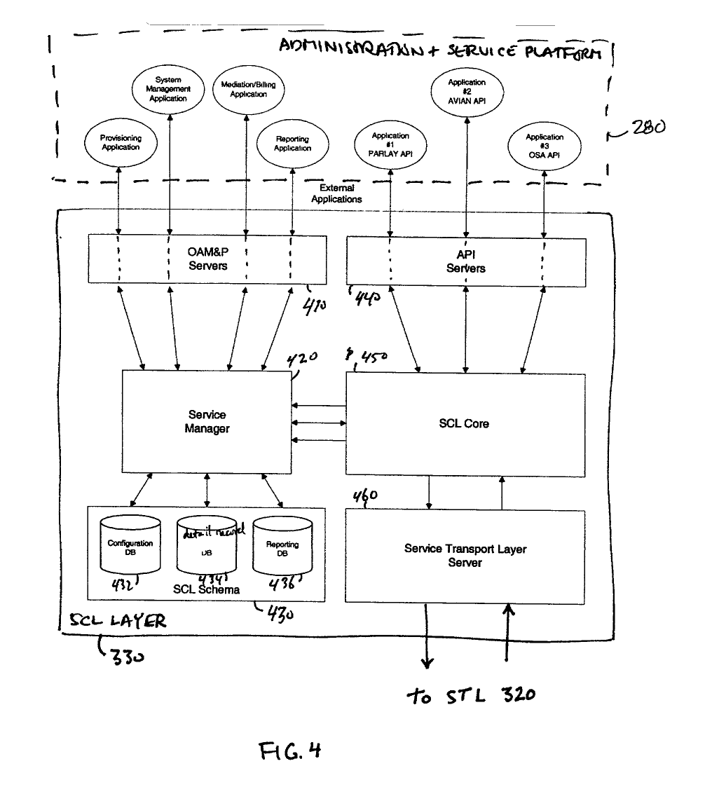

Referring to FIG. 4, SCL 330 includes modules related to management and monitoring of services as well as modules related to execution of the provisioned service logic.

The SCL is responsible for housing a configuration database 432 as well as the detail record database 434. The SCL also interfaces with external network management systems for provisioning and fault management. The SCL collects data from the STL, external applications, and the API state machines on a per service request basis in order to generate Detail Records (DR) for billing or service request statistics.

A service manager 420 is responsible for managing a variety of service related functions as well as interfacing to the core to perform management functions. OAM&P (Operations Administration Maintenance and Provisioning) servers 410, which include a provisioning server, a network management server, a billing server, and a reporting server, provide interfaces between the operator systems and service manager 420. The OAM&P servers 410 insulate the service manager from the external clients as well as provide the framework necessary to prioritize access to management resources.

One function of service manager 420 is to respond to requests from a provisioning application to create and provision particular services. Service manager 420 creates the service and stores information related to the service in a configuration database 432. Service manager 420 communicates with an SCL core 450 to enable the service so that user sessions for that service are handled by the MSSP.

As part of the provisioning process, an operator can also identify one or more subscriber groups associated with the service. A subscriber group may be used to group users by privileges or by rate plan. Subscriber groups are made up of one or more users who share common properties for billing or network access purposes. A user constitutes an individual subscriber who will have a session with the packet switched network with one or more active flows. The subsections that follow will examine each of these concepts in greater detail. Subscribers are not necessarily individually provisioned in the MSSP.

Service manager 420 communicates with SCL core 450, which generally controls real-time aspects of monitoring and control of service interactions. SCL core 450 is the central runtime component of the SCL software architecture. The SCL core provides an event-based execution environment in which queues of pending message are service. The SCL core uses scripts to serve as the sequencer with respect to message processing. The scripts serve as linked lists of calls to compiled code resulting in desirable performance characteristics while maintaining a greater degree of flexibility with respect to specifying system logic. Some messages that are processed by the SCL core are associated with detection points that have been detected in the data flowing through the MSSP. In processing a message, SCL core 450 executes a script associated with the message. Typically script execution is suspended when a request to a remote server is made and a response or acknowledgement is required. A suspended script will later resume execution when the remote server provides the reply or acknowledgement that the originally blocked the script. While suspended other messages are processed by scripts.

SCL core 450 uses a STL server 460 as an interface to STL 320, and uses an API server 440 as an interface to applications executing on service platforms external to the MSSP.

SCL Core 450 calculates statistics of system performance as well as support the generation of detail records. These statistics are updated under the control of scripts executing in the execution environment. Periodically, SCL core 450 exports these calculated statistics to service manager 420, which uses them to compute derived statistics. Service manager 420 calculates system performance statistics based on information it receives from SCL core 450.

A script that implements service logic for a particular provisioned service may control a number of separate data flows. A flow is an abstraction used to describe the movement of packet data through the MSSP. A user may have multiple active flows under the context as a single session. Flows are dynamic in nature and will typically be set up and torn down as the user interacts with the network resources providing the various services. A single flow belongs to a single user under the context of a single service. A flow may also be said to indirectly belong to a particular operator since a user belongs to a single operator subscriber base. Note that a user may have multiple flows active simultaneously that belong to different services. For example, a user may have multiple windows open on a wireless device browsing different web sites each implementing a particular service.

SCL core 450 collects per flow meters that may be further aggregated into per session meters. Flow detail records can be conditionally written when a flow is terminated. Detail records created to provide a partial or complete summary of a flow are known as flow detail records (FDR's). It is possible to create multiple detail records for a single flow. Each detail record contains a sequence number to allow the records to be ordered relative to the order they were written within the context of a given user session or particular flow.

SCL core 450 provides a set of real-time statistics that are sent to service manager 420 for distribution to external processes configured to receive real-time monitoring data. The real-time statistics sent by the core are sent periodically based on the configuration of the MSSP. Real-time statistics may be on a per operator, user group or service basis.

SCL core 450 periodically sends operator real-time records to service manager 420 to provide real-time performance metrics on a per operator basis. The real-time records are typically computed within the SCL core in real-time as messages are processed within the execution environment. A configurable periodic timer initiates the real-time data export process that packages up the real-time data elements and sends them to the service manager for distribution and further computation. Service real-time records and subscriber group real-time records are similarly sent periodically from the SCL core to provide real-time performance metrics on a per service basis. SCL 330 supports a number of detail record formats that will allow data to be captured at a number of levels. These include Application Detail Records, Service Detail Records, User Detail Records, and Flow Detail Records. The service manager computes statistics for intervals of time, for example, for 5 minute, hour or all day intervals and writes these computed statistics to the reporting database.

SCL 330 is able to register and report events on a per flow basis under control of the scripts that execute the service logic. The process begins when a service application registers a notification detection point. The registration process involves setting up a set of patterns that will be matched against flows in real-time. Typically the patterns are keyed off the control messages of the protocol being used at layers 2-7. For instance, a TCP session that is in the process of opening will exchange a number of protocol messages between the two hosts. The exchange of the TCP protocol control messages cause the flow state machine to walk through the connection establishment states. The notion of a detection point begins with identification a set of transitions within the state machine as places where state transitions can be detected and reported to an external application. A detection point can be further qualified with a set of conditions such that only certain flows matching the conditions will be reported to an external application. In practice a detection point is a combination of the specific point within the state machines as well as a set of conditional variables. Event reporting is the process of notifying an external application of when a flow passes one or more detection points and it meets the conditional parameters. The actual events reported are a function of the protocol being implemented. The notion of event reporting is typically most useful for connection-oriented protocols since these types of protocol implement well-defined state machine. Event reporting on connection less protocols like UDP are not typically very useful as there is not state machine leaving little to report. In many cases the state machine is implemented in a higher-level protocol layered on UDP. An example of a protocol in this class is WAP 1.0. The WAP stack defines an application layer protocol over UDP that implements a state machine. Detection points can be defined on application protocols contained within UDP packets.

A request detection point can also be a point at which applications can take control of the session while the data communication for the flow is suspended. An application typically registers request detection points at strategic points where it would like to get involved in the connection setup or protocol processing. When packet within a flow passes matches all the conditional parameters associated with a detection point, flow processing is suspended and an event message is sent to the application that set the detection point. The application may take actions to change the default handling of the flow. The changes may involve redirecting a connection request to a different destination address or terminating the connection completely. The idea is that the application has the ability to determine how the connection request is routed through the network as well as the ability to configure flow or session parameters for metering or security purposes. An application must respond to a request event in a timely fashion. Failure to do so would potentially cause unnecessary delays as well as a great deal of queuing. If the application fails to respond to the request event within a timeout period (configurable), the suspended flow is resumed and the default actions configured for the service are performed. Request detection points allow an application to selectively interrupt flows to execute service logic that determines how the service is provided. While request detection points are most useful for connection-oriented protocols they may also be applied to nonconnection oriented protocol like DNS, DHCP, or RADIUS. In these protocols a request detection point may be used to intercept and serve a request, as well as to synchronize the response with the application running externally to the MSSP. A request detection point might be useful on the response to a RADIUS authentication request since it would notify the application and allow it to send commands to the MSSP to configure the filters for the flow before returning the authentication response. This sequence would ensure that the proper filters were applied to the flow from the start. Note that both types of detection points (request and notification) are typically used simultaneously in a complimentarily fashion to allow the application to control and monitor the interaction.

An example of a request detection point on a TCP Open where the application supplies a destination address in the connect message and asks to receive event reports until the session is established successfully or the session fails because it cannot be established.

The detection point may be registered as a request detection point, or an notification detection point. When a flow encounters a request detection point, packet forwarding will be halted and the SCL Core is notified. The response from the service logic instructs the STL how to proceed and packets in the flow are delivered accordingly. If the detection point was registered as a notification detection point, events will be sent for cases where the packets in the flow match the conditions specified when the notification detection point was registered. Note that the detection point condition string may contain wildcard card characters that may be used to specify a wide range of matching values. Upon receiving the registration request the STL will install the detection point and send a confirmation indicating the success of the registration operation.

The STL allows applications to specify filters to apply to flows on a session (user) or per flow basis. This functionality can be used to create a walled garden to enforce subscription-based models where subscribers are only allowed to access sites related to their subscriptions. The functionality can also be used to create network resident firewalls. The functionality can be applied dynamically such that if a subscriber where to sign up for a pay per view site an application could update the filters applied to an individual subscriber to give the subscriber access to the functionality for the contracted period. The dynamic nature of the filtering features can also be used to open holes on dynamic ports on command by a media gateway using the API. The operator can therefore ensure that only authorized streaming traffic is allowed on the carrier network. This is in contrast to typical IP routers that allow static access lists to be created to manage packet filtering. The MSSP allows this functionality to be performed by the hardware and the embedded software more efficiently than the user of static lists or the user of an application server software approach. The MSSP access lists will be configurable on a per flow basis, however, it is more likely that access lists will be controlled on a per user or session basis.

The MSSP allows applications to manage VPNs and flows routed over the VPNs within the system. The use of VPNs is on the increase as Internet and network security attacks grow broader in scope. The MSSP is capable of supporting client initiated VPNs as well as NAS-Initiated (Network Access Server) VPNs. The MSSP provides the capability to configure each VPN type and allow applications to control when the VPNs are established and what traffic is routed over the established VPNs. Alternately the MSSP is capable of metering those VPNs that simply pass thru the MSSP from the user client to a remote Internet termination point.

An application associates itself with a detection point by identifying a detection point class, detection point, and the conditions that must exist in order to create a control dialog with the application. Such a detection point is then called an Initial Detection Point (IDP). Traffic passing through the state machine that does not match the given condition criteria is unaffected. When conditions match the given criteria, a control dialog is created between the state machine and the application, and the application is notified of the event.

When the detection point has been armed to provide only an event report, the control dialog only exists long enough to send the event notification, and packet processing by the state machine continues unimpeded. When the detection point has been armed as a trigger, the control dialog persists after the event report, and processing of the packet by the state machine is suspended until a response if received from the application. Triggers allow the application to influence the subsequent control decisions made by the state machine.

When a packet is suspended at a detection point, the application has several different ways to respond. It may simply allow packet processing to be resumed normally, without influencing any control over the state machine. This type of response is called Continue. Another possible response is called Release, which directs the state machine to abort further processing of the packet. The application may also provide a new destination for the packet by using a Connect response. Finally, an application may provide state machine-specific control over the state machine's subsequent processing of the packet by using a Control response. The control dialog continues after the application has provided the trigger response only when additional event reports have been requested.

An application may also use the control dialog created by an IDP to request subsequent event reports from other detection points in the same execution context of the state machine. Event detection points may be requested by an application in conjunction with the Continue and Connect trigger responses, or they may be requested with a separate Event Report Request message. Event detection points only apply to the state machine context that created the control dialog and do not cause event reports to be generated by any other context of that state machine. Event detection points are automatically removed when the corresponding state machine context is removed.

A control dialog is always created when conditions match arming criteria at an initial detection point. Typically an application will arm only one initial detection point within a given detection point class (state machine) as a trigger, and use the resulting control dialogs to request any additional event reports that are needed by the application. An application may, however, arm multiple IDPs within a given detection point class. Each IDP operates independently of the other, and the resulting control dialogs are distinct. In some cases it may be possible for the application to have multiple concurrent control dialogs established for the same state machine context, but no advantage can be taken of this fact; the control dialogs must still be managed independently as if different applications were involved.

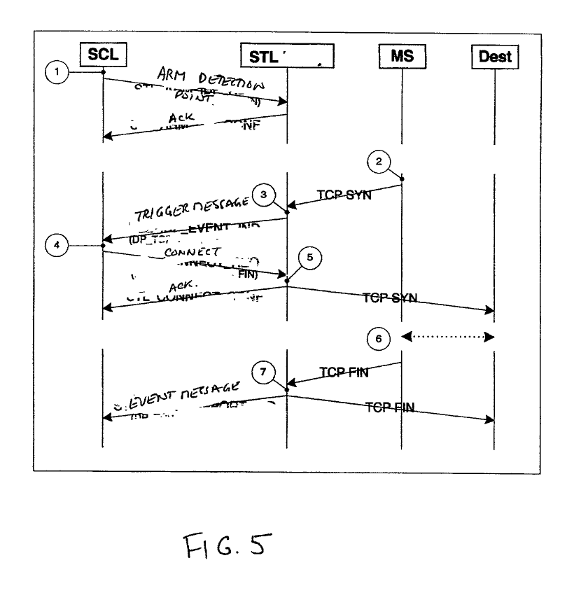

Referring to FIG. 5 a high-level illustration of the detection point message flow for a hypothetical application that is to control TCP connections to a specific destination address:

1. Application in the SCL arms a detection point associated with the detection of a SYN packet, which is associated with the creation of a TCP flow. The detection point criteria identify the target destination address to be controlled.

2. The Mobile Station (MS) initiates a TCP connection to the target destination address, causing a TCP SYN packet to be sent towards the target destination address.

3. As the TCP SYN packet transits the MSSP, the TCP state machine in the STL evaluates the conditions at the TCP SYN state detection point and finds a match with the arming criteria stored by the SCL at step 1. Processing of the SYN packet is suspended and an initial detection point indication is sent to the SCL to initiate a control dialog with the SCL.

4. SCL evaluates the data provided by the detection event indication and determines that the TCP connection should be directed to a different destination. It responds to the STL with the address of different destination and requests to be informed when the TCP connection is terminated.

5. The STL acknowledges the connection request, forwards the TCP SYN packet on to the new destination, and arms the TCP connection termination detection point to provide an event report for this connection.

6. The new destination and the mobile station (MS) complete the TCP protocol to open a connection and exchange data.

7. The mobile station (MS) initiates the TCP disconnect procedure, causing a TCP FIN packet to be sent. As the FIN packet transits the MSSP, the TCP state machine in the STL Entity evaluates the conditions at the TCP FIN detection point and finds a match with the arming criteria stored by the SCL at step 5. The requested Event Report Indication is sent to the SCL. Since this detection point was armed as an event report and not a trigger, processing of the TCP FIN packet proceeds and the packet is forwarded on to DEST, and the TCP protocol to close the connection is completed.

In this example, the detection point was associated with a TCP state machine. The STL layer includes a number of state machines including: load monitoring, Session Group, Subscriber session, RADIUS protocol, DHCP protocol, DNS protocol, TCP protocol, and IP protocol

The criteria that specify the characteristics of a IP detection point include: Operator ID, Subscriber Group ID, Session ID, Source IP Address. Source IP Port number, Destination IP Address, Destination IP Port number, and application.

For the TCP state machine, detection points that can be registered include: FORWARD₁₃SYN, REVERSE₁₃SYN, TCP₁₃ACK, FORWARD₁₃FIN, REVERSE₁₃FIN, and RESET

The SCL can request that the STL configure packet filters for an active session. Typically this request will be made as a result of the STL detecting a subscriber login. The subscriber login remains suspended while the SCL creates the session and configures the appropriate packet filters for the session. Following successful completion of the packet filter request, the SCL sends the Subscriber Login Conf message to allow the subscriber session to proceed.

An example of overall operation of the MSSP is as follows.

1. At the beginning of this example, Operator, Subscriber Groups, Services, Applications already configured in MSSP database. For example, they are permanently resident in the MSSP or have been provisioned by the operator.

2. STL processes start up, initialize, and send a STL Up Indication messages to SCL. The message indicates what configuration data is needed by the STL entity and what capabilities the STL entity supports.

3. SCL processes start up, initialize, and obtain configuration from MSSP database. SCL responds to STL Up Indication messages with an STL Version Config Request.

4. Each STL entity completes version negotiation with SCL and receives the configuration data that was requested in the STL Up Indication message.

5. Each STL entity that supports detection points registers each detection point, specifying the IDP and trigger attributes and indicating which criteria parameters are relevant to each.

6. The detection point registration messages cause SCL to create contextual objects for later management of detection point resources.

7. Internal application services are activated in the MSSP.

8. SCL API Servers begin accepting external application connections.

Later, after the MSSP is operating:

1. An external application connects to API Server and initiates a session, providing its identity and security information.

2. The API Server authenticates the application, finds everything in order, and confirms the session is open by sending a response back to the application.

3. The Application and API Server negotiate the protocol version to be used for the remainder of the session.

4. If the application is not already preconfigured with the Services it provides, the Application obtains the list of Services that it is configured to provide from the API Server.

5. the Application issues an Arm IDP request to the API Server, identifying the MSSP service, detection point, and arming criteria.

6. The SCL API Server validates the request against the application's configured privileges and service criteria restrictions, and then forwards the Arm IDP request to the SCL core.

7. The SCL core script validates the request, associates the indicated MSSP service with the application, increments counters in the corresponding application and service contextual objects, then forwards the Arm IDP request to each STL entity that supports that detection point.

The detection point arming criteria is also saved in the SCL core contextual object so that an arming request can be generated if an STL entity that supports this detection point is subsequently added.

8. As each STL entity confirms the arming of the detection point, the corresponding detection point resources are added to the MSSP service contextual object. The addition of the first DP resource causes the MSSP service state to change to “Deployed” and the confirmation of the Arm IDP request is sent to the API Server (after the script for the confirmation increments counters in the corresponding application and service contextual objects).

9. The API Server relays the Arm IDP confirmation to the application.

10. Following the same procedure, the application arms any additional initial detection points it needs to implement the service(s) it provides.

11. Application waits for an IDP Event Indication message.

Later, when a mobile user wants to use the service:

1. The user turns on the phone (MS), initiating a RADIUS request.

2. MSSP RADIUS proxy forwards the RADIUS request to the RADIUS server.

3. MSSP RADIUS proxy receives the successful response from the RADIUS server, determines the Operator ID and Subscriber Group ID that the mobile subscriber belongs to, and sends an STL Subscriber Login Request to the SCL core.

4. The SCL core script creates a new session contextual object, associates it with the subscriber group and operator contextual objects, assigns the session to a single STL entity, and sends that entity an STL Create Session Request message.

5. The STL entity reserves resources for the session and responds with an STL Create Session Confirm message.

6. When the SCL core receives the confirmation, any meters and packet filters that are configured for the operator and subscriber group are configured for the new session by sending the appropriate messages to the STL entity. The default meter masks for the operator and subscriber group are combined and configured in one request to the STL entity.

7. When all session configuration is complete, the SCL core responds to the MSSP RADIUS proxy with an STL Subscriber Login Conf message.

8. The MSSP RADIUS proxy returns the successful RADUS response back to the MS.

Later, while the user is has a data connection:

1. Mobile user initiates a browser connection.

2. The protocol packet requesting the new connection is routed through hardware controlled by the STL entity that this subscriber session was assigned to.

3. The STL entity evaluates the criteria at its armed initial detection point and discovers a match.

4. The STL entity suspends processing of the packet and sends an STL IDP Event Indication message to SCL.

5. The SCL script associates the suspended flow with the service that contains the reported IDP, increments service and application trigger counters, and forwards the IDP Event Indication to the API Server.

6. The API Server forwards the IDP Event Indication to the application.

7. The application examines the IDP event parameters and determines a different destination address for the MS connection, which it supplies in a Connect Request message to the API Server.

8. The API Server forwards the Connect Request to the SCL core.

9. The SCL core script increments service and application trigger response counters and sends an STL Connect Request to the STL entity with the suspended packet flow.

10. The STL entity modifies the packet with the updated destination address and resumes packet processing, returning an STL Connect Conf to the SCL core.

11. The SCL core relays the connect confirmation to the API Server.

12. The API Server relays the connect confirmation to the application.

13. The destination that was chosen by the application receives the connection request from the MS and opens the connection with the MS.

14. The MS and destination server exchange data.

15. Periodically during the life of the connection, STL Flow Meter Indication messages are sent from the STL entity to the SCL core to report the values of meter elements configured for that session.

16. The SCL core accumulates the data in the periodic flow meter indications, updating flow, session, subscriber group, operator, service, and application contextual objects.

17. The MS disconnects from the destination server.

18. The STL entity detects the end of the flow and sends the final STL Flow Meter Indication for the flow to the SCL core. No detection point arming by the application or SCL is needed to accomplish this action. However, there are many scenarios where the STL entity will not know when the flow has been terminated. In these cases the SCL core must implement a flow timeout policy and force the flow to be released by the STL entity.

19. The SCL core script accumulates the data in the flow meter indication as before, updating flow, session, subscriber group, operator, service, and application contextual objects.

20. The SCL core script produces flow, subscriber, service, and application detail records corresponding to the terminated flow. The association between the flow and service contextual objects allows the billing plan ID configured in the service to be placed in the flow detail record, or the application may have provided the billing plan ID to be placed in the flow detail record.

21. The detail records are stored in the MSSP database until collected by the operator's billing subsystem.

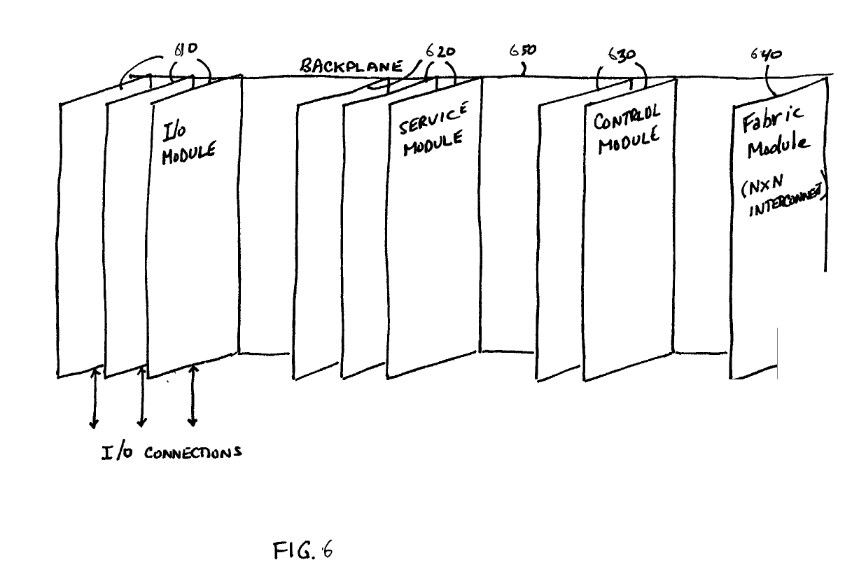

Referring to FIG. 6, MSSP 260 is chassis based with a backplane 650 connection a number of different modules. There are four module types: an I/O module 610, a service module 620, a control module 630, and a fabric module 640. Optionally, there are redundant control, SS7, I/O and fabric modules in the system. The number of I/O modules 610 is dependent upon the external connections needed of the wireless system in which the MSSP is used. The number of service modules 620 is generally dependent upon the number of subscribers as well as the number and complexity of the services the MSSP needs to support. I/O modules 610 and service modules 620 are not necessarily associated in a one-to-one relationship. Control module 630 can alternatively be external to the chassis or may be in a mixed configuration in which case some functionality is provided on internal control module 630 and associated functionality is provided in an external computer. All module types can be replicated for one to one redundancy. For example there can be two fabric modules in the MSSP.

Fabric module 640 provides an N-by-N interconnection for the other modules, whereby any module can pass packet data or other information directly to another module.

Control module 630 provides a platform for hosting software-based layers of the MSSP architecture. In this version of the system, the control module uses a Sun Microsystems SPARC based processor.

I/O modules 610 and service modules 620 perform hardware-based processing of data packets. The typical data path for a packet is input to the MSSP at an I/O module 610. The I/O module sends the packet through fabric module 640 to a service module 620. The service module either immediately processes the packet and sends it to an I/O module 620 for egress from the MSSP, or holds the packet for further processing.

If service module 620 needs to communicate with the software-based SCL, it passes messages through fabric module 640 to control module 630 which hosts the software layers. Control module 630 implements a TCP/IP communication stack. If SCL 330, which executes on control module 630, needs to communicate with a service platform 280, it passes such communication through the TCP/IP stack and through fabric module 640 to an I/O module 610 which provides an interface with the service platform.

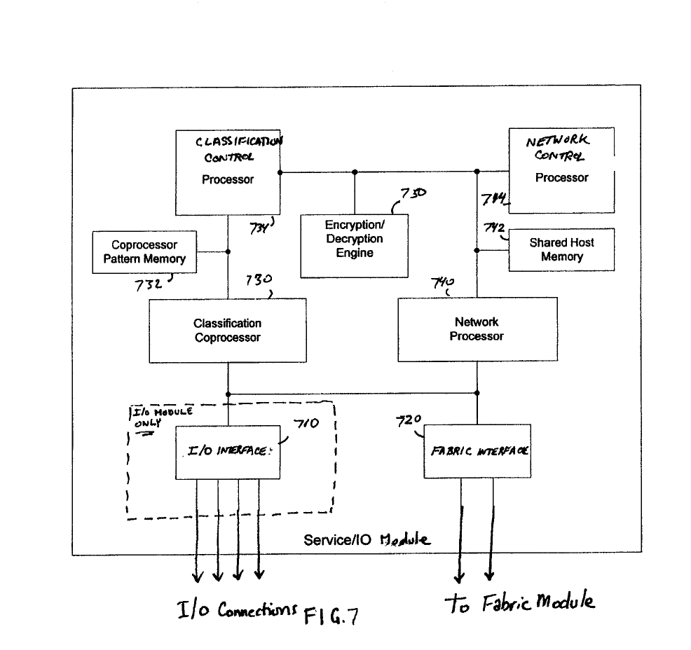

Referring to FIG. 7, I/O module 610 and service module 620 share a common hardware architecture. A fabric interface 720 provides a communication path to fabric module 640 for passing data to other modules in the backplane. In this version of the system, fabric interface uses a Gigabit Ethernet (GE) to communicate with fabric module 640. A network processor 740 communicates with fabric interface 740 and receives packets that are passed to it through fabric module 640. In this version of the system, network processor is an Intel IXP 1240 processor. Network processor 740 is controlled by a network control processor 744 and makes use of a shared host memory 742, which is shared between the network control processor and the network processor.

I/O module 610 also includes an I/O interface 710. A service module 720 does not need to include this interface, or if present, does not typically make use of it. I/O interface 710 provides external data connections for the MSSP. For instance, data passes between the MSSP and mobile network 120 and between the MSSP and Internet 140 over such an I/O interface. Packets pass directly between I/O interface 710 and network processor 740.

A classification coprocessor 730 “snoops” on data packets passing between network I/O interface 710 and fabric interface 720 and network processor 740. Classification coprocessor is configured to detect particular types of packets by detecting characteristics of those packets at any protocol level. The patterns that the classification coprocessor detects are stored in a coprocessor pattern memory 732, which is set a classification control processor 734. When classification coprocessor 730 detects a particular type of packet is it looking for, it informs network processor 740 with little delay after network processor 740 has received the packet. In this version of the system, classification coprocessor 730 is manufactured by Solidum Systems, and provides detection of packets based on regular expression specifications. These regular expressions can involves features of the packet at one or more protocol layers.

Software layers of the MSSP architecture, which execute on control module 630, set the packet patterns (i.e., detection points) to be detected by communicating with classification control processor 734 through fabric module 650, fabric interface 720, and network processor 740.

Service module 620 also includes and encryption/decryption engine 750, which is used by the service module for maintaining tunnel connections to external services. For example, communication between MSSP 250 and a content provider 150 may be over a secure tunnel. The encryption/decryption engine implements the encryption and decryption needed in hardware.

A typical path for a packet flowing from mobile network 120 to Internet 140 enters MSSP 260 through an I/O interface 710 on an I/O module 610. The packet passes to network processor 740 on the I/O module. Network processor 740, possibly aided by classification coprocessor 730, determines whether the packet is part of a communication session with a Mobile Station (MS) 132 that is supposed to be managed by the MSSP. If it is, network processor 740 passes the packet directly to a service module 620 through fabric interface 720 and fabric module 650. The packet enters the service module through its fabric interface 720 and passes to network processor 740 on the service module. Classification coprocessor 730 snoops on the packet passing from fabric interface 720 to network processor 740. If the packet matches a pattern that the classification coprocessor is configured to detect, the packet coprocessor informs the network processor and network control processor 744.

If the packet does not need to processing by software layers of the architecture, network processor 740 send the packet out fabric interface 720 to an I/O module for transmission out of the MSSP. The I/O module receives the packet, which is passed through network processor 740 to I/O interface 710 and out of the MSSP.

If the packet is associated with a detection point at which intervention of a software layer of the architecture is required, network processor 740 on the service module does not immediately send out the packet. Rather, network control processor 744 communicates with the software by communicating through the fabric module to the control module where the software is hosted. The network control processor eventually receives a response from the software layer, and controls the network processor to handle the packet appropriately. If a response does not come within a configured period, the packet is handled using default processing rules.

If the packet is associated with a detection point that does not require suspending the packet but does require notification of the software layers, network control processor 744 sends a message to the control module and network processor 740 passes the packet on to the appropriate I/O module without waiting from instructions from the control module.

Operation of MSSP 260 uses models, such as finite state models, to monitor communication sessions between the Mobile Stations (MSs) 132 and content providers 150. MSSP 260 is configured to enable detection points at transitions in these call models, for example at states or state transitions of finite state models. The call models occur at various protocol layers. For instance, at a lowest layer, a call model is associated with an entire PDP context. At higher layers, call models are associated with transport layer flows, such as TCP flows. The states of the call model relate to the initial establishment and then termination of the flows. At still higher protocol layers, call models are associated with application layer interchanges, for example associated with communication sessions following the HTTP protocol.

Service logic, which may execute on a service platform 280, on an external service platform 282, or on the control module internal to the MSSP, registers particular detection points of which it requests to be notified or at which it requests to receive control of the session. The detection point is typically identified by a particular state or state transition in one of the call models, as well as by parameters of that detection point. An example is setting a detection point when a TCP session is attempted to be established to a particular IP address, or when an HTTP session requests a particular Web page.

The SCL of the MSSP, which executes on a control module in the backplane, receives the request to register a detection point, an issues corresponding requests of the STL, which in turn requests configuration of the network processor and classification coprocessor on a service module.

The approach described above supports a wide variety of service types and billing models. Some illustrative examples are described below.

A first service type is similar to a toll-free telephone calling model. In this service, the user will not be billed for the data communication with the content provider. An example of this is a florist service that is accessed as if it were a web server at an Internet host named 800Flowers.com.

In a setup phase, an external service platform communicates with the MSSP to request to be notified if a user attempt to retrieve a Web page from a host named 800Flowers.com. In the MMSP, the SCL receives and validates the request, and requests the STL to set up hardware triggers and events necessary to perform the detection.

When a user attempts to retrieve a web page from his MS from 800Flowers.com, the configured trigger is detected. The STL informs the SCL of the detection, which notifies the external service platform. The external service platform determines where the request should be routed, in this case to FTD.com, and informs the SCL, which passes a redirection instruction to the STL, which requests that the network processor redirect the remainder of the flow to FTD.com rather than 800Flowers.com. The original packet that was detected is now passed to the Internet, modified to reflect the redirected address.

When the session with FTD.com is completed, the SCL generates an IPDR that reflects the time and amount of data transferred during the session, which it forwards to the billing node. The operator will then bill FTD for this portion of the user's communication, rather than billing the user.

Another service is similar to wireless prepaid voice services. The MSSP is provisioned to detect setup of PDP contexts from particular users. When the MSSP detects a new PDP context, application logic, which in this case is resident on the control module, communicates with an external accounting server to determine whether the user has a positive balance in his account. In one version of this service, this accounting server is accessible over an SS7 network using the same protocol that is used for voice prepaid services.

After the SCL validates the user, the user's data is passed through the MSSP without modification. When the user terminates the session, the SCL passes a command to the accounting server to decrement the user's balance based on the duration or amount of data passed during the session.

In another example, the network 100 is utilized to provide a sponsored packet switched data service accessed by a user on a fully sponsored basis by another. Both the application based service (the content or user interactive service) and the network service (the packet data transport) are offered on a no charge, no toll basis to the user. Prior to using the service, the user is aware that by connection to the service that neither “air time” packet data transport charges or other content or usage service charges will apply. Optionally, the user may be notified at the time of requesting a service that it is sponsored.

A network operator manages and controls the sponsored packet switched data services, which includes any and all unique network addresses that identify the packet switched data service, the policy decisions that determine how, and to which, packet switched data service provider the user is directed, and the policy decisions that determine which sponsor is to be billed for the session and on what basis. The policy decisions for selection and billing may include rules that incorporate pre-agreements between the operator and third parties, either sponsors or service providers, as to the selection of the service provider and the method and basis of payment for the sponsor. A policy decision of which service provider to make a connection to may be made at the time of the service request based upon such factors as a user identity, a location of the user, a time of day, a user class, a service provider class, network conditions, pre-agreement rules, and/or governmental regulations. For example, a policy decision of which sponsor to bill and on what basis can be made at time of the service request based upon similar factors such as the user identity, the location of the user, time of day, user class, service provider class, network conditions, pre-agreement rules, and/or governmental regulations.

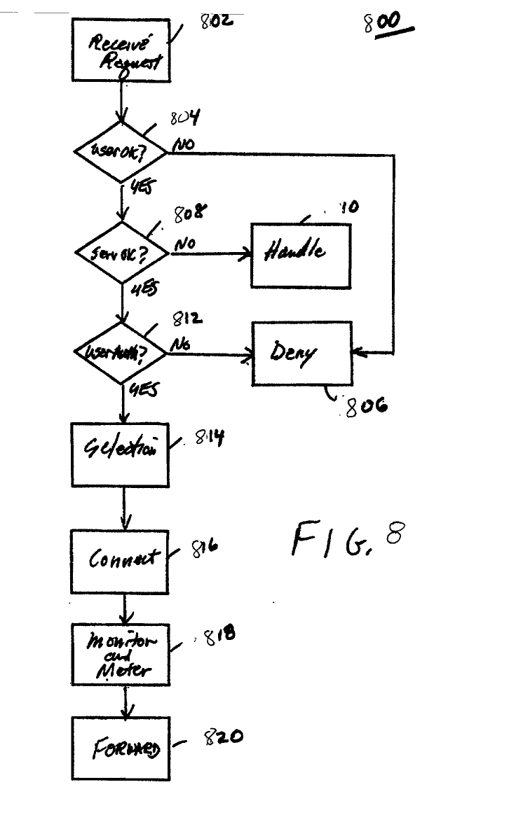

Referring to FIG. 8, a sponsored packet switched data service process 800 includes receiving (802) a request for a packet switched data service. This request typically originates with the user connecting over the air interface to the network 100. The request may also be in response to a push operation by a service sponsor inviting the user to try the sponsor's service. A push operation is one in which the sponsor initiates activity.

The process 800 determines (804) whether the user is authorized to access the network 8 for packet switched data services. User class information and location information needed to make later policy decisions about the packet switched data service is collected during the determination (804). If the user is not authorized to access the network 100 the process 800 denies (806) the user request.

If the user is authorized to access the network 100 for packet switched data services, the process 800 determines (808) whether requested service is a sponsored packet switched data service. If the service request is not for a sponsored packet switched data service, the process 800 handles (810) the user request with other service request processes.

If the service request is for a sponsored packet switched data service, the process 800 determines (812) whether the user is authorized to access the specific requested sponsored packet switched data service. If the user is not authorized to access the specific requested packet switched data service, the process 800 denies (806) the user request.

If the user is authorized to access the specific requested packet switched data service, the process 800 selects (814) a service provider for the specific requested switched data service. The selection (814) is made in conjunction with a stored rule base implementing policy decisions of an operator of the network 100 based on one or more factors. Factors may include a user identity, a location of the user, a time of day, a user class, a service provider class, network conditions, pre-agreement rules, and/or governmental regulations. For example, if the operator of network 100 would normally supply specific requested switched data service, the rule base selection preferentially chooses the operator as the service provider.

The selected service provider, i.e., sponsor, identity may be a class, i.e., a subsequently selected service provider, or rules for determining the sponsor from later acquired information. The operator, in the case of where it is providing the service, will be named as the sponsor. If a third party is chosen as the service provider and has agreed to sponsor the service, then it will be identified as the sponsor. The process 800 may use another rule base that implements policy decisions of the operator for selecting the sponsor. In an example, the selection is based on a pre-agreement between a third party and the operator to be the sponsor or co-sponsor of a particular service.

The process 800 connects (816) the user to the selected service provider and initiates a packet switched data service session. The process 800 monitors and meters (818) the packet switched data session, gathering, for example, billing and other information generated during the session. The type of billing and other information generated depends upon the type of packet switched data service provided and the sponsor. In an example, the type of information gathered will be a policy decision of the network operator. In the case of a third party sponsor, the policy decision is usually based upon a pre-agreement between the operator and the third party. For example, if a third party service provider is the sponsor of a free packet switched data service, the billing information is gathered for network connection charges that are based on a number of criteria. Additionally, information about the use of the data service may be gathered, so that the provider may charge such expenses to, for example, its marketing and advertising accounts. Similarly, when the service provider is the operator it typically has no out-of-pocket costs, but may need to know network usage and data service usage so can transfer this information to, for example, its marketing and advertising accounts.

During the session, the process 800 may forward charging information in real time, or in near real time.

When the session is complete, the process 800 transfers (820) the billing and other information to an appropriate node. The node credits to the account(s) of the identified sponsor(s) for payment and information units stored for information transfer. Also, any usage information, as necessary, is reconciled for user records by the node.

In another example, the network 100 is utilized to provide transaction based packet switched data services to a user on the basis of purchased services being supplied by a service provider to the user. The service provider may be a single third party, multiple third parties, and/or an operator of the network 100. The purchased service may be an application-based service, e.g., content of a service or a user interactive service, a product, e.g., a software program, a license, e.g., rights to use a software program, goods for later delivery, e.g., items for pickup by a user at a facility, vending outlet or sales location, or for delivery by the service provider to the user's location. The network service for the packet switched data transport that is involved in the delivery of the service is bundled in the total purchase price of the service, i.e., the user does not incur a separate charge or toll for any network service necessary to fulfill the purchase request. Prior to using the service, the user is aware that by connection to the service the services are offered on a fee basis and include bundled network service and transport charges. In an example, the user may be notified at the time of requesting a service that it is transaction based on a fee basis.

An operator of the network 100 manages and controls the transaction based packet switched data services. This includes any and all unique network addresses that identify the packet switched data service, the policy decisions that determine how, and to which, packet switched data service provider the user is directed, and the policy decisions that determine how the user is to be billed and on what basis, and any policy decisions that are entrusted to the service provider. The policy decisions for selection and billing may include rules that incorporate any pre-agreements between the operator and third parties, such as service providers, as to the selection of the service provider and the method and basis of payment for the user. For example, the policy decision of which service provider to make a connect to may be made at the time of the service request based upon such factors as the user identity, the location of the user, time of day, user class, service provider class, network conditions, pre-agreement rules, and/or governmental regulations.

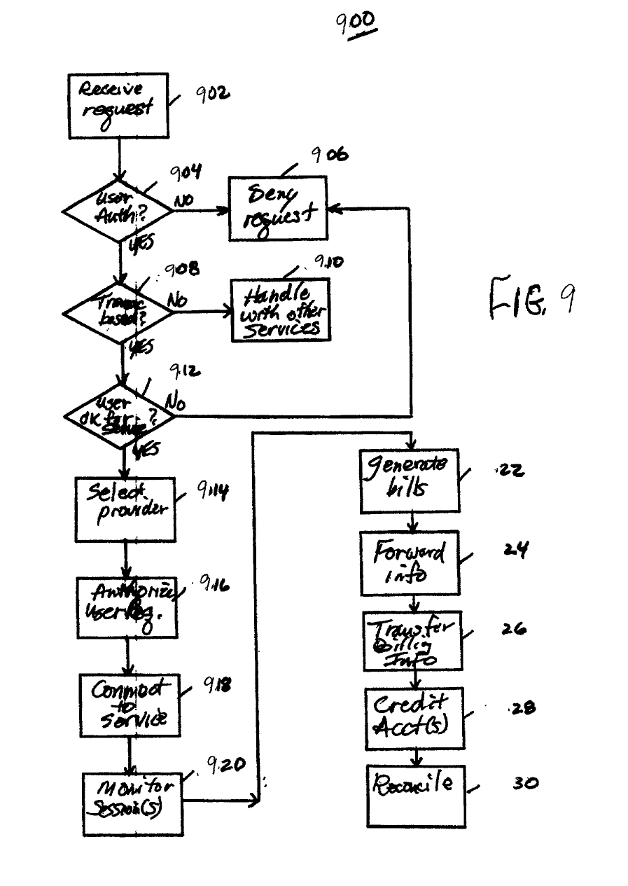

Referring to FIG. 9, a transaction based packet switched data service process 900 includes receiving (902) a request from a user for a packet switched data service. The service request may originate from the user through the air interface to the network 100 or the service request may come in response to a push operation by a service provider inviting the user to purchase its service. A push operation is one in which the sponsor initiates activity.

The process 900 determines (904) whether the user is authorized to access the network 100 for transaction-based packet switched data services. User class information and location information needed to make later policy decisions about the requested transaction-based packet switched data service collected during the determination (904). If the user is not authorized to access the network 100 the process 900 denies (906) the user request.

If the user is authorized to access the network 100 for transaction-based packet switched data services, the process 900 determines (908) whether requested service is a transaction-based packet switched data service. If the service request is not for a transaction-based packet switched data service, the process 900 handles (910) the user request with other service request processes.

If the service request is for a transaction-based packet switched data service, the process 900 determines (912) whether the user is authorized to access the specific requested transaction-based packet switched data service. If the user is not authorized to access the specific requested transaction-based packet switched data service, the process 900 denies (906) the user request.

If the user is authorized to access the specific requested transaction-based packet switched data service, the process 900 selects (914) a service provider for the specific requested transaction-based packet switched data service. The selection (914) is made in conjunction with a stored rule base implementing policy decisions of an operator of the network 100 based on one or more factors. Factors may include a user identity, a location of the user, a time of day, a user class, a service provider class, network conditions, pre-agreement rules, and/or governmental regulations. For example, if the operator of network 100 would normally supply specific requested transaction-based packet switched data service, the rule base selection preferentially chooses the operator as the service provider.

The process 900 authorizes (916) the user's request. Authorization (916) may include participation by the service provider and/or the operator of the network 100. The service requested by the user is transaction-based so authorization (916) involves determining if the user making the request has sufficient credit or payment facilities to pay for the anticipated debt resulting from the service being provided. If the user is not authorized to make the purchase of the selected transaction-based service the process 900 denies (906) the service to the user.

If the user is authorized to proceed with the purchase of the selected transaction-based service, the process 900 connects (918) the user to the identified service provider and a packet switched data service session is initiated. The initiated transaction-based packet switched data service may encompass one or more purchases of transaction based services by the user from the identified service provider. The process 900 monitors (920) each individual purchase session within a single user session and generates (922) billing and other information for the purchase or purchases. During each purchase session, the process 900 may forward (924) billing information to a node in real time, or near real time. The type of billing information and other information will depend upon the type of packet switched data service provided and the provider. In an example, the type of information gathered will be a policy decision of the network operator. In the example of a third party provider, the type of information gathered will usually be based upon a pre-agreement between the operator of the network 100 and the third party provider. For example, purchase authorization may limit the maximum network resources allowed to be used in attempts to deliver the transaction based service. A pre-agreed policy may determine under what conditions the service may be delivered and what constitutes the limits of reasonable attempts to deliver the service by the network operator.

For example, if poor network conditions result in an unacceptably high number of packet retransmissions during the service delivery attempt due to unrecoverable packet error conditions between the provider and the user, pre-agreed policy rules may include a threshold at which the service delivery attempt is aborted, the purchase canceled and the purchase session is prematurely declared complete. Under more typical “normal” conditions, a purchase session is determined as complete when the delivery of the transaction-based service is finished.

When the purchase session is complete, the process 900 transfers (926) the billing information and other information to the node. Billing may be based on many factors, such as volume, duration, time, final destination, location, quality of service, SMS, served IMSI/subscriber, reverse charging, free of charge, flat rate, and bearer service.

The process 900 credits (928) billing units to an account of the user for payment and information units stored for information transfer. There may also be an exchange of information between the service provider and network operator related to the purchase session completion. The process 900 reconciles (930) any usage information to service provider records.

If the service session between the user and service provider encompasses multiple purchase sessions, the user may choose to make further transaction based service requests. If the user has no further requests and/or all purchase sessions are completed, then the service session is complete. If the user chooses to make further and/or multiple purchase requests from the same service provider during the same service session, then these additional requests are handled by process 900.

In alternative hardware configuration, rather than using a backplane with a fabric card, a single combined I/O module and service module provides external data connections and packet processing. This combined card is hosted in a computer chassis, such as a “pizza box”.

In other embodiments, an MSSP is used to provide Voice over IP (VoIP) services in which packetized voice traffic is passed between the mobile network and the fixed network.

In alternative embodiments, the approach described above is applied to Mobile Virtual Network Operator (MVNO) environments. In one such environment, multiple operators share a single MSSP. Services, user groups, and other configuration are done one a per-operator basis. In this way, data communication between a subscriber of one virtual operator is handled by services for that operator. That is, a flow for a subscriber only triggers services provided by that operator. The operator of the physical network can receive usage information, for example, to bill the virtual operators for their use of the physical network. The virtual operators receive detail records for their subscribers so that they can bill their subscribers, service providers, and advertisers on a service model basis. In another MVNO environment, one MSSP may route communication for a particular virtual operator to another network location, for example, to another MSSP, without processing the flows.

In alternative embodiments, different types of wireless architectures than GSM/GRPS are supported. For instance, the MSSP described above can serve as a gateway for a variety of different types of wireless data networks, including CMDA, TDMA, and third-generation (3G) systems.

Also, in the GSM/GPRS case, the functionality of the MSSP can be combined with other nodes. For example, the functionality of a GGSN and an MSSP can be combined into one node.

An MSSP can also control communication that does not involve a wireless data network. For example, the model approach with external service platforms is applicable to monitoring and controlling communication sessions passing between networks, such as between a subscriber's network and a wide area backbone network, or between a wireless LAN and a fixed network.

Various alternative hardware architectures are also feasible. For example, in alternative architectures, the functionality of the I/O modules and service modules could be combined, and more or less of the functionality supported on the control module can be hosted with the MSSP chassis.

It is to be understood that the foregoing description is intended to illustrate and not to limit the scope of the invention, which is defined by the scope of the appended claims. Other embodiments are within the scope of the following claims.

What is claimed is:

1. A method of providing a sponsored packet switched data service comprising:
receiving a request in a network for a sponsored packet switched data service from a user;
determining a sponsor for the requested service in accordance with stored policies;
determining a billing in accordance with the stored policies;
monitoring a session between the user and the sponsor; and
billing the sponsor on completion of the session.

2. The method of claim 1 in which the stored policies include pre-arrangements between a network provider and sponsors of packet switched data services.

3. The method of claim 1 in which the stored polices include factors.

4. The method of claim 3 in which the factors include a user identity, a user location, a time of day, a user class, a service provider class, network conditions, pre-agreement rules and/or governmental regulations.

5. The method of claim 1 in which the sponsor is a packet switched data service provider.

6. The method of claim 1 in which the sponsor is an operator of the network.

7. The method of claim 1 in which the sponsor is a third party packet switched data service.

8. The method of claim 1 in which monitoring the session comprises:
detecting a start of the session with a set of detection points;
tracking the session in a session charging record; and
detecting an end of the session with the set of detection points.

9. The method of claim 8 in which detecting a start of the session comprises: detecting starts of sub-sessions within the session with the set of detection points.

10. The method of claim 9 in which tracking further comprises: tracking the sub-sessions.

11. The method of claim 10 in which detecting the end comprises: detecting the end of each of the sub-sessions within the session with the set of detection points.

12. The method of claim 8 in which billing comprises: sending the charging record to the sponsor.

13. The method of claim 1 in which the network is a second generation wireless network.

14. The method of claim 1 in which the network is a Global System for Mobile communication (GSM) network.

15. The method of claim 14 in which the GSM network is General Packet Radio System (GPRS) enabled.

16. The method of claim 1 in which the network is a Time Division Multiple Access (TDMA) network.

17. The method of claim 1 in which the network is a Code Division Multiple Access (CDMA) network.

18. The method of claim 1 in which the network is a Universal Mobile Telecommunications System (UMTS) network.

19. The method of claim 1 in which the network is a TETRA network.

20. The method of claim 1 in which the network is a Tetrapol network.

21. The method of claim 1 in which the network is a DECT network.

22. The method of claim 1 in which the network is an AMPS network.

23. The method of claim 1 in which the network is a wireless local area network (WLAN).

24. The method of claim 1 in which the network is a third generation wireless network.

25. A method comprising:
in a network, receiving a request from a user for a packet switched data service;
determining a provider for the service according to stored policies;
determining a billing arrangement for the service according to the stored policies; and
tracking the service between the user and the provider.

26. The method of claim 25 in which the stored polices include how the user is to be billed and a basis for the billing.

27. The method of claim 26 in which the stored polices include policy decisions that are entrusted to the provider.

28. The method of claim 25 in which the stored polices include pre-arrangements between an operator of the network and the provider.

29. The method of claim 25 in which the stored policies include matching a provider to a user's time of connection.

30. The method of claim 25 in which the stored policies include matching a provider to a user's location.

31. The method of claim 25 in which the stored policies include matching a provider to a time of day.

32. The method of claim 25 in which the stored policies include matching a provider to a user class.

33. The method of claim 25 in which the stored policies include matching a provider to a service class.

34. The method of claim 25 in which the stored policies include matching a provider to network conditions.

35. The method of claim 25 in which tracking comprises:
detecting a start of the service with a set of detection points;
tracking the service in a charging record; and
detecting an end of the service with the set of detection points.

36. The method of claim 35 in which detecting a start of the service comprises: detecting starts of sub-services within the service with the set of detection points.

37. The method of claim 36 in which tracking further comprises: tracking the sub-services in the service with the set of detection points.

38. The method of claim 37 in which detecting the end comprises: detecting the end of each of the sub-sessions.

39. The method of claim 25 in which billing comprises: sending the charge record to the user.

40. The method of claim 25 further comprising:
determining whether the user is authorized to use the service.

41. The method of claim 40 in which determining comprises:
checking a user account for payment history.

42. The method of claim 40 further comprising:
billing the user upon completion of the service; and reconciling billing between a network operator and the provider.

43. The method of claim 40 in which the service includes multiple transaction services represented by multiple sub-services.

44. The method of claim 25 in which the wireless network is a second generation wireless network.

45. The method of claim 25 in which the wireless network is a Global System for Mobile communication (GSM) network.

46. The method of claim 45 in which the GSM network is General Packet Radio System (GPRS) enabled.

47. The method of claim 25 in which the wireless network is a Time Division Multiple Access (TDMA) network.

48. The method of claim 25 in which the wireless network is a Code Division Multiple Access (CDMA) network.

49. The method of claim 25 in which the wireless network is a Universal Mobile Telecommunications System (UMTS) network.

50. The method of claim 25 in which the network is a TETRA network.

51. The method of claim 25 in which the network is a Tetrapol network.

52. The method of claim 25 in which the network is a DECT network.

53. The method of claim 25 in which the network is a AMPS network.

54. The method of claim 25 in which the network is a third generation wireless network.

55. The method of claim 25 in which the network is a wireless local area network (WLAN).

56. The method of claim 1 in which the network is a fixed network.

57. The method of claim 25 in which the network is a fixed network.
